(19) United States
(12) Patent Application Publication
(10) Pub. No.: US 2009/0210276 A1
(43) Pub. Date: Aug. 20, 2009

(54) AD HOC AND OPPORTUNISTIC TRANSPORTATION SERVICES

(75) Inventors: John C. Krumm, Redmond, WA (US); Eric J. Horvitz, Kirkland, WA (US); Ruston Panabaker, Redmond, WA (US); Michael Lewis Seltzer, Seattle, WA (US); Neil W. Black, Seattle, WA (US); Jeffrey D. Couckuyt, Bothell, WA (US); Ivan J. Tashev, Kirkland, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/033,713

(22) Filed: Feb. 19, 2008

(51) Int. Cl. G06Q 10/00

(52) U.S. Cl. 705/8; 705/1; 705/14

(57) ABSTRACT

Individuals can be organized into travel groups in plans constructed in advance or in real-time to save resources and travel in an efficient manner. Multi-segment trips between starting points and destinations can be constructed with several vehicles, including private, public, and commercial transportation assets. Numerous requests for real-time or planned recurrent commutes by a population of users can be considered in a larger analysis that seeks to optimize one or more attributes such as vehicle usage and/or greenhouse emissions. Data concerning multiple related individuals can be gathered and analyzed—based upon the analysis, a determination can be made if it is logical to group individuals together such that they physically travel together. A transportation asset provider and/or individuals can be offered a reward to become part of the travel group and/or to perform specific tasks related to the travel group, such as using a vehicle with a certain fuel type.

### TECHNICAL FIELD

The subject specification relates generally to traffic routing and in particular to generating real time transit lines.

### BACKGROUND

Computer-driven route planning applications are used to aid users in locating points of interest, such as particular buildings, addresses, and the like. Additionally, in several existent commercial applications, users can vary a zoom level, thereby enabling variation of context and detail as a zoom level of a map is altered. For example, as a user zooms in on a particular location, details such as names of local roads, identification and location of police and fire stations, identification and location of public services, such as libraries, museums, and the like can be provided to the user. When zooming out, the user can glean information from the map such as location of the point of interest within a municipality, state/providence, and/or country, proximity of the point of interest to major freeways, proximity of the point of interest to a specific city, and the like.

Furthermore, conventional computer-implemented mapping applications often include route-planning applications that can be utilized to provide users with directions between different locations. Pursuant to an example, a user can provide a route planning application with a beginning point of travel and an end point of travel (e.g., beginning and ending addresses). The route planning application can include or utilize representations of roads and intersections and one or more algorithms to output a suggested route of travel. These algorithms can output routes depending upon user-selected parameters. For instance, a commercial route planning application can include a check box that enables a user to specify that she desires to avoid highways. Similarly, a user can inform the route planning application that she wishes to travel on a shortest route or a route that takes a least amount of time (as determined by underlying algorithms). Over the last several years, individuals have grown to rely increasingly on route planning applications to aid them in everything from locating a friend's house to planning cross-country road trips.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Conventionally, individuals organize themselves into travel groups for various reasons, such as sharing common expenses (e.g., fuel costs). Oftentimes, a person with a vehicle offers to transport individuals she is acquainted with to a common location. However, there can be more commercial practice of travel groups (e.g., commonly known as ‘car pools’), where a private party offers to transport individuals in exchange for a fee and/or service.

The disclosed innovation enables automatic organization of individuals in a travel group (e.g., a group of individuals in common transit traveling to a universal location). Information of different users can be analyzed and based upon the analysis a determination can be made as to individuals that would benefit from membership in a travel group. According to one configuration, a reward can be offered to a member of the travel group for participation, such as a driver of a vehicle; the reward can be general (e.g., an amount of money) or specific (e.g., a coupon to a restaurant frequented by the driver). In one embodiment, abstract ride tokens can be employed, where such tokens represent a currency for use in a market of opportunistic ride sharing, where providing rides, rides of particular types, or of particular distance lead to the accrual of one or more ride tokens that are stored and tracked in an online tracking tool. Such tokens can be exchanged for rides, allowing for an economics of give and take of the usage and provision of trips to others.

Practice of the disclosed innovation differs from conventional public transit. Generally, commercial organizations announce departure and arrival times and a user can decide if the available times meet user needs. It would appear illogical to organize travel groups organically since the conventional system has been in user for a relatively long time with little change. However, unexpected benefits can be provided to users through practice of the disclosed innovation, such as allowing compromises to be made and benefits to be bestowed upon different parties while multiple individuals can still have at least some needs met.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative system for travel group organization in accordance with an aspect of the subject specification.

FIG. 2 illustrates a representative system for travel group organization with a detailed analysis component in accordance with an aspect of the subject specification.

FIG. 3 illustrates a representative system for travel group organization with a detailed management component in accordance with an aspect of the subject specification.

FIG. 4 illustrates a representative system for travel group organization with a detailed transaction component and detailed disclosure component in accordance with an aspect of the subject specification.

FIG. 5 illustrates a representative route production system for a travel group in accordance with an aspect of the subject specification.

FIG. 6 illustrates a representative methodology for producing a route related to a transit assembly in accordance with an aspect of the subject specification.

FIG. 7 illustrates a representative methodology for organically created a travel group in accordance with an aspect of the subject specification.

FIG. 8 illustrates a representative methodology for engaging in a reward transaction with a user for participation in a travel group in accordance with an aspect of the subject specification.

FIG. 9 illustrates an example of a schematic block diagram of a computing environment in accordance with an aspect subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. It is to be appreciated that determinations or inferences referenced throughout the subject specification can be practiced through use of one or more logical or statistical inferential methods, which can be broadly referred to as artificial intelligence or as automated reasoning and learning. These automated reasoning and learning methods can include statistical inference and related approaches to use machine learning to construct inferential models, probabilistic inference, search and optimization, constraint satisfaction, etc.

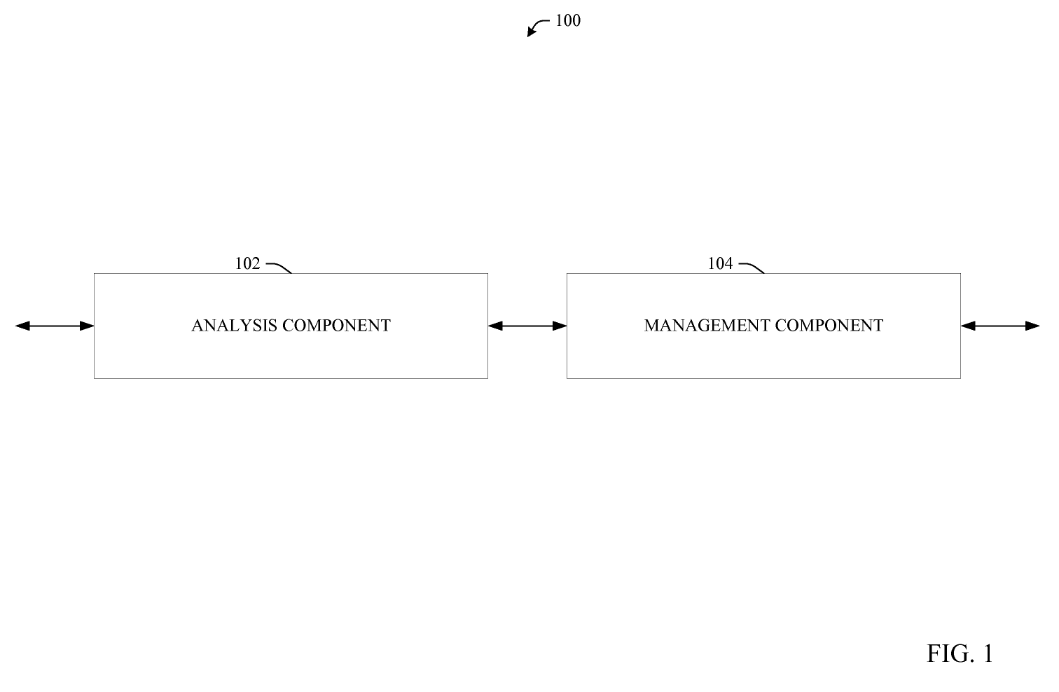

Now referring to FIG. 1, an example system 100 is disclosed for producing travel group. Oftentimes, multiple individuals travel to one location independently (e.g., travel while utilizing their own vehicle). Benefits can be gained by these users if they take the journey as a member of a travel group, where a travel group can be at least two individuals in common transit traveling to a destination along a common route. For instance there can be shared costs (e.g., fuel), improved travel experience (e.g., conversation while upon a journey), more efficient travel (e.g., the ability to use carpool lanes to avoid traffic congestion), and the like in addition to more general benefits, such as lower vehicle emissions.

With the disclosed innovation, a travel group can be created organically, in an offline manner through the analysis of multiple sets of revealed or monitored starting points and destinations, but also in a more real-time manner, even extending into times a user is in transit. Various information that relates to different users, traffic patterns, and the like can be collected and an analysis component 102 can evaluate transit information related to at least two users. For instance, a relatively large number of users can be leaving a suburban town to attend a concert in a downtown area. The analysis component 102 can gather metadata related to the users (e.g., travel time, personal desires, and the like) and attempt to match different users together. For instance, two users can both desire to leave about two hours before the concert and desire to stop for a meal prior to the concert—these users can be matched together by the analysis component 102. In addition, other data pertaining to the users can be evaluated, such as potential road conditions, anticipated traffic patterns, safety, weather, and the like.

Evaluated information as well as a result of the evaluation can be made available to a management component 104 that automatically organizes at least two users that have transit information evaluated into a travel group, organization occurs as a function of the transit information evaluation. Returning to the concert example, the management component 104 can place matched individuals into a travel group (e.g., make a temporary association in a computer database between group members). The management component 104 can include specific criteria to use in order to determine members to include in the travel group, such as individuals scheduled to travel along similar paths. In addition, various security measures can be used to organize people together. For instance, the management component 104 can limit organization to individuals that have had previous interactions with one another, people who can assume that there is trust that comes with working at the same organization, people within certain relationships within an encoded social networking system, such as being within a specific degree of separation, people with similar situations (e.g., women within a certain age that are from one town), and so forth. Other information that can be used in making such matches can include publicly available information on experiences with a driver or passenger that is posted as a compilation of comments or measures of the quality of service within a web service.

According to one embodiment, the transit information includes schedule information, traffic data, time detail, contextual metadata (e.g., anticipated weather conditions), modes of transport available, a route, or a combination thereof. The system 100 can configure such that the travel group journey upon one personal vehicle (e.g., as passengers of an automobile owned by a group member). In addition, the management component 104 can organize at least two users that have transit information evaluated into a travel group in real time (e.g., organize a user that is driving with a user yet to leave, where a route is produced taking the driving user to the non-driving user). It is to be appreciated that the analysis component 102, the management component 104, as well as other components disclosed in the subject specification can implement upon a vehicle, a personal electronic device (e.g., cellular telephone, laptop computer, wristwatch, etc.), a central server, as well as other configurations.

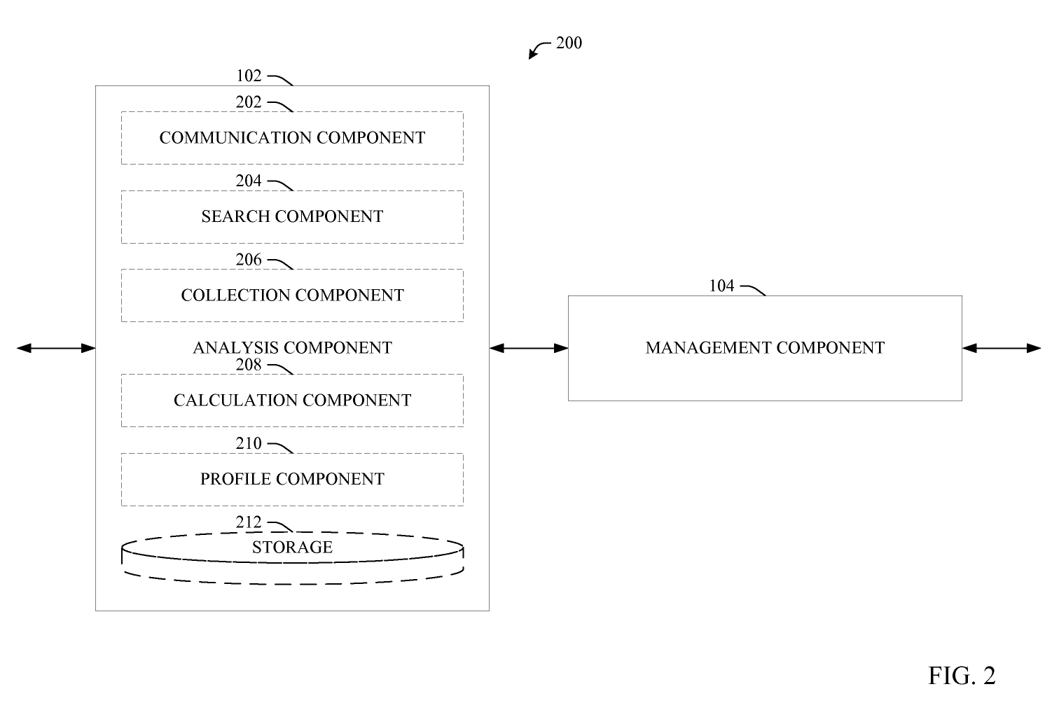

Now referring to FIG. 2, an example system 200 is disclosed for producing travel group with an illustrative expanded analysis component 102. The analysis component 102 can evaluate information related to individuals capable of being part of a travel group, including personal information, traffic patterns, contextual data such as time/date data, and the like. A communication component 202 can engage with other devices to transfer information, such as to send a request for information, receiving information from an auxiliary source, etc. Operation can take place wirelessly, in a hard-wired manner, employment of security technology (e.g., encryption), etc. Information transfer can be active (e.g., query/response) or passive (e.g., monitoring of public communication signals). Moreover, the communication component 202 can utilize various protective features, such as performing a virus scan on collected data and blocking information that is positive for a virus.

A search component 204 can locate at least one source of transit information related to a user (e.g., a user that can be included upon a travel group). According to one embodiment, the search component 204 can monitor open airwaves to determine if data can be extracted, such as traffic reports of a radio broadcast. In addition, the search component 204 can retain a database of reliable sources and continuously update the database as reliability information is gathered.

A collection component 206 can obtain transit information related to a user, oftentimes from at least one source located by the search component 204. Analysis can be performed upon the data, where a result of the analysis is used to make various determinations, such as a determination of individuals that would benefit from a placement in a travel group. It is possible that such a large amount of information can be gathered that it can be beneficial for filtering to take place. The collection component 206 can filter out obtained data that is not from select sources (e.g., reliable sources), blocking data determined irrelevant from other components, as well as other filtering configurations.

To assist in determining members that should be placed in a travel group, various computations can be made by a calculation component 208. The analysis component 102 can identify individuals capable of being placed in a travel group and evaluate transit information related to an identified user. Based upon the analysis, a score can be assigned to the identified user such that various evaluation results correlate to a score. For instance, if a user has a history of being willing to take part in a travel group, then a positive score can be assigned to the user. However, if the same user also has been assigned negative feedback from users of previous travel groups, then the score of the user can be lowered. A cumulative score can be used to determine users that should take part in a travel group.

User history, vehicle history, and the like can be organized by a profile component 210, where a profile is retained upon storage 212. User history can become important when determining if a user should be organized into a travel group. Observations can be made on user actions (e.g., how a user has previously traveled, user response to previous travel groups, and the like) and these actions can be retained in a profile.

Different pieces of information, such as collected materials, component operating instructions (e.g., of the search component 204), source location, the profile maintained by the summary component 206, etc. can be held on storage 212. Storage 212 can arrange in a number of different configurations, including as random access memory, battery-backed memory, hard disk, magnetic tape, etc. Various features can be implemented upon storage 212, such as compression and automatic back up (e.g., use of a Redundant Array of Independent Drives configuration). Evaluation results, transit information, and the like can be made available to a management component 104 that automatically organizes at least two users that have transit information evaluated into a travel group, organization occurs as a function of the transit information evaluation.

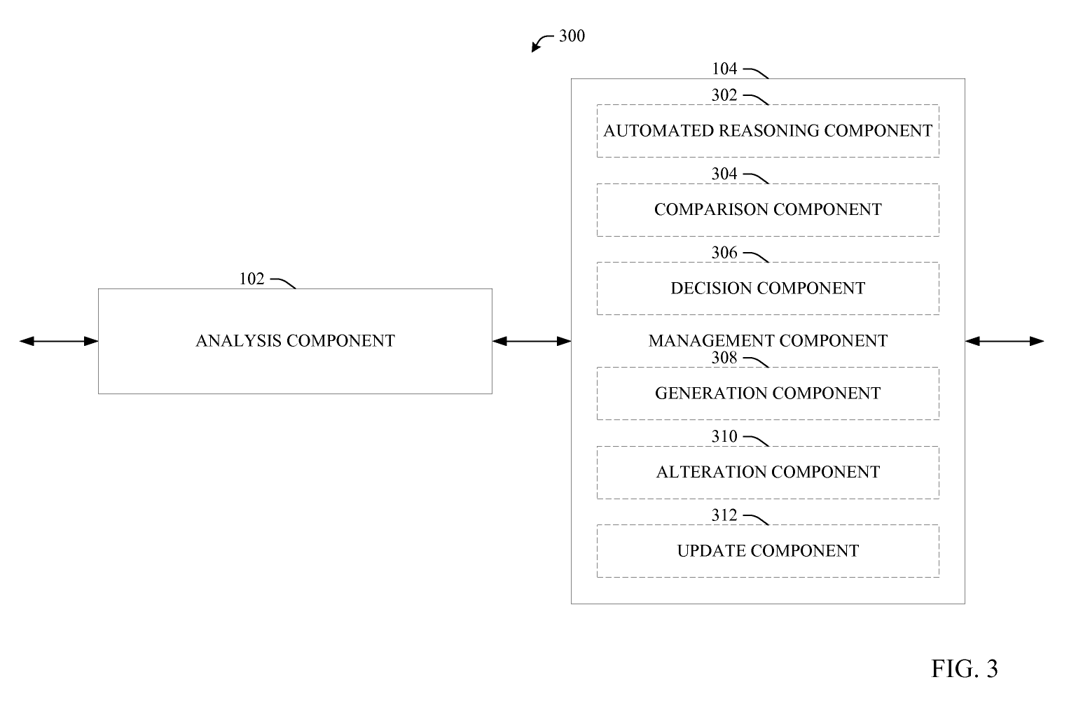

Now referring to FIG. 3, an example system 300 is disclosed for producing travel group with an illustrative management component 104. Transit information can be collected by an analysis component 102 (e.g., through utilization of the collection component 206 of FIG. 2) that evaluates transit information related to at least two users. According to one embodiment, the analysis component 102 can transfer evaluation results to a management component 104 that automatically organizes at least two users that have transit information evaluated into a travel group, organization occurs as a function of the transit information evaluation.

An automated reasoning component 302 can make at least one inference or at least on determination in regard to transit information evaluation or automatic travel group organization through automated reasoning and/or learning. For example, the automated reasoning component 302 can infer preferences of an individual, determining, for example, that a user continuously rejects offers to join a travel group indicates that the user does not want to be part of the travel group as opposed to the offers being poor. In addition, an example determination facilitated by the automated reasoning component 302 can include determining that there is not a suitable travel group match for a user. A community of offers, rejections, and selections can be used within a logical or statistical preference analysis and recommender system often referred to as a collaborative-filtering system, and such a collaborative filtering system can harness community experiences to personalize the recommendations made for individuals.

The automated reasoning component 302 can employ one of numerous methodologies for learning from data and then drawing inferences and/or making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems.

In one embodiment, recurrent commuting patterns can be considered by an automated optimization system that attempts to minimize and/or maximize one or more properties or attributes of multiple recommendations. A multi-attribute utility function can be used to encode the objective function that is being optimized. For example, numbers of vehicles used in morning and evening commutes or related recurrent patterns of travel. With a goal of creating ongoing carpools to related locations, sets of preferences of tuples provided by individuals, including preferred pick up locations, pick up times, destination locations, destination drop off times, and cost functions capturing varying degrees of imperfect matching in location and times can be considered. An optimization method can be used, such as heuristic or comprehensive search over possible trips to identify a best set of trips and passenger pick ups and drop offs. Such optimizations can include computation of single vehicle trips as well as sequences of pick ups and drop offs, that is, trips involving a sequence of multiple cars and drivers. The optimization method can seek to minimize some measure of cost, such as numbers of cars, total amount of fuel used, total amount of emitted carbon dioxide (or other emitted greenhouse gases), etc. while maximizing some utilitarian measure of satisfaction of numbers of people being transported.

A global utility function could be made explicit and could be refined over time by an organization overseeing an opportunistic transportation service. Likewise, groups of people who abide by a similar utility model, such as reducing the total pounds of CO2 emitted by transportation, or the number cars, or even enjoyable conversations based on a matching of intellectual interests might form separate clubs and services that seek to optimize the preferences of the specific transportation club. The management component 104 can implement multiple requests for users to be placed upon a travel group together to minimize overall cost to users, minimize distance traveled, minimize greenhouse gas emissions, etc. in real-time or offline. For instance, a multitude of requests can be considered and based upon the considerations, different users can be placed in different groups to minimize greenhouse gases.

A large scale analysis can be employed periodically, where periods can go from minutes to hours, to daily or weekly optimizations, and lead to the generation of sets of computed routes, with pick ups and drop offs. Where multi-segment, multi-vehicle routes are considered, uncertainties in timing of locations can be addressed by considering in the optimization as costs the potential inconveniences that can come with wait times at points where one or more passengers moves from one car to another, as the passenger is passed like a baton in a relay race to trips, per the optimization. The expected duration of wait times at these transfer points, as well as the probability distributions (e.g., variances by time of day and day of week, weather, etc.) could be considered in the cost analyses of multi-hop trips. Such baton passing would allow available seats in a vehicle to be opened up and then refilled through a sequence of drop offs and pick ups. Scheduled public transportation could be considered as segments in such optimizations of the transport of single passenger, groups of passengers, and larger optimizations across multiple desired trips over a region.

The management component 104 can organize at least two travel groups, organization of the two travel groups occurs to optimize travel for the organized groups. A first travel group of the user can take place upon a personal vehicle (e.g., user-owned bicycle), a public transportation vehicle (e.g., bus), or a commercial transportation vehicle (e.g., rickshaw) and a subsequent travel group of the user can take place upon a personal vehicle, a public transportation vehicle, or a commercial transportation vehicle that is not used in the first travel group. For instance, a user can hop between two different busses for the two different travel groups. However, the user can also transfer between different kinds of transports—a user can be in a taxi as part of the first travel group and ride on a subway train as part of the second travel group.

In one embodiment, commercial transportation services such as shuttle services, taxis, and limousines can serve explicitly in a mix of available services, being woven in on demand or as backups when needed to complete end-to-end trips between starting points and destinations. Such services might even take part in special token-based economics where dollar values are assigned to tokens that are employed in a specialized road service. In some cases, the use of commercial transportation services can be based on load and availability of transportation assets, e.g., empty taxis returning to a base at an airport following the dropping off of passengers might dynamically indicate to a coordinative opportunistic transportation service that seats are available and then be pressed into service as a segment of a chain of rides that a person or group needs. Such opportunistic services can be made available to a service at discount rates as the trip would otherwise be wasted on simply bringing the resource back to a base, such as an airport or other home for a commercial transportation vehicle.

Computation results of the calculation component 208 of FIG. 2 can be balanced against one another by a comparison component 304. The comparison component 304 can attempt to match different users together, where matched users are organized into a travel group. Matching can take place through various configurations, including weight factors, required characteristics, and the like. The comparison component 304 can match users according to their scores—users with highest scores can be matched (e.g., #1 and #2 match, #3 and #4 match, etc.), scores can match to reach a desired average (e.g., with a desired average score of about ‘150’, user with score about ‘88’ can match with a user with score about ‘62’), randomly with user scores above a certain threshold, and so forth. In matching users for a travel group, characteristics of the users discovered through profile components can be used (e.g., user who enjoy riding at or below a speed limit can be matched with a user that historically drives at or below a speed limit).

Based upon a result of the comparison component 304, a decision component 306 can choose members that should be placed into a travel group. For instance, about six individuals can be determined to be quality matches for placement into a travel group. However, none of the six individuals owns a vehicle that can carry more than about four passengers. The decision component 306 can arrange individuals into two travel groups, commonly using optimization techniques.

A route enabling users to form a travel group (e.g., a directions set instructing user on how to meet), a route enabling users to complete an objective, etc. can be constructed by a generation component 308. The generation component 308 can create a route for the travel group, use of the route enables at least two members of the travel group to achieve a personal objective (e.g., a passenger to reach a location and a diver to be paid a reward). The created route can be presented to at least one user—if the user does not approve of the created route, then the created route can be deleted and a new route can be generated (e.g., a new route is generated taking into account reasons why the user rejected the initially created route).

The system 300 can operate dynamically, such that routes are produced to users in real time (e.g., as a user embarks upon a route). Therefore, a route could go through a change performed by an alteration component 310 (e.g., changing paths to take a user to a new location to add a new member to a travel group). It is to be appreciated that the alteration component 310 can modify a route created by the generation component 308 as well as a route created from another device (e.g., a mobile route production device). The alteration component 310 can change a route, use of the changed route enables at least two members of the travel group to achieve a personal objective (e.g., travel to a concert).

The route can be presented to at least one user and reaction of the user to the route can be monitored. User reaction can be used to alter a profile retained by the profile component 210 of FIG. 2 by an update component 312 as well as operation of components disclosed in the subject specification. The profile component 210 of FIG. 2 can utilize the update component 312 that modifies the profile as new observations are made, new information is gathered, etc. In addition, the update component 312 can change contents of a central server used to organize travel groups.

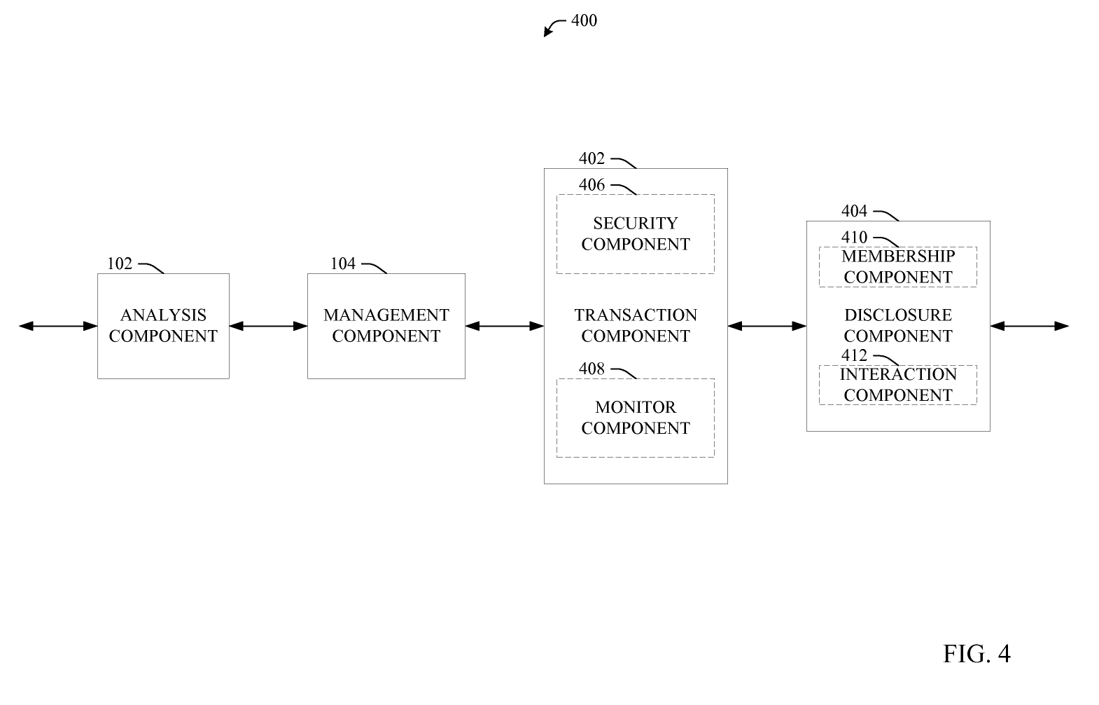

Now referring to FIG. 4, an example system 400 is disclosed for producing travel group with an illustrative expanded transaction component 402 and disclosure component 404. Information related to user transit (e.g., a user upon a vehicle, walking, swimming, and the like) can be collected and evaluated by an analysis component 102. Results of the evaluation can be made available to other components and a management component 104 can automatically organize at least two users that have transit information evaluated into a travel group, organization occurs as a function of the transit information evaluation.

It can be possible for members of the travel group to be provided a reward for being part of the travel group, performing certain actions consistent with the travel group, and the like. A transaction component 402 can perform a fiscal operation in regard to transit information evaluation or automatic travel group organization. The transaction component 402 can perform actions to meet constraints, such as debiting a user account and crediting a provider account (e.g., a government can offer a reward to individuals that volunteer to become part of a travel group). While fiscal amounts are commonly transacted, it is to be appreciated that other commodities can be exchanged, such as coupons, meeting of contractual obligations (e.g., canceling of a task to be performed), tax credits, etc.

A security component 406 can regulate operation of the transaction component 402. Oftentimes, the transaction component 402 can transfer money from a banking account of a company to an account of a user. Since this can be considered sensitive information, the security component 406 can protect this transfer through implementation of encryption, password protection, and the like. Moreover, the security component 406 can check fiscal operations for consistency and perform correction operations. If a wrong amount of money is sent from one party, then the security component 406 can identify an error and send notice that a different amount should be sent.

A monitor component 408 can observe actions pertaining to the system 400, such as where a user travels, if a user leaves a vehicle operating the system 400, if a user makes a purchase, if a company performed in an agreed manner, and the like. The monitor component 408 can compare observed actions against transactional criteria to determine if a fiscal operation is proper to occur. Based upon a result of the comparison, the monitor component 408 can regulate operation of the transaction component 402.

A disclosure component 404 can provide travel group metadata to at least one user of the travel group (e.g., a vehicle passenger or operator, as a pedestrian, etc.). The travel group metadata can include a produced route, information that concerns members of a travel group, and the like. A non-exhaustive list of disclosure components include a display screen, touch screen, speaker system, virtual reality environment, Braille production system, printer, etc. However, the disclosure component 404 can implement as a transmitter device that emits information to a screen, as well as other configurations. In addition, the disclosure component 404 can present information in multiple formats, such as showing a video with audio capabilities. Moreover, the disclosure component 404, as well as other components disclosed in the subject specification can implement upon a personal electronic device (e.g., cellular telephone, personal digital assistant, etc.), upon a vehicle (e.g., automobile, motorcycle, bicycle, airplane, helicopter, motorboat, self-balancing transportation device, etc.), etc.

While a user can be organized into a travel group by the management component 104, the system 400 can configure such that the user is not placed into the travel group with providing authorization. A membership component 410 can make a request to at least one user to become part of the travel group. According to one embodiment, the membership component 410 makes a static request, such that the user can either become part of a travel group or not become part of the travel group. However, configurations that are more complex can be practiced that are dynamic between the system 400 and a user. For example, about five members can be presented to a user to be part of a travel group, where the user can accept about two members while rejecting about three members. Based upon a response of the user, a route can be produced that facilitates the user to join with about two accepted members.

A response provided by the user (e.g., from dynamic communication, static communication, etc.) can be obtained by an interaction component 412. The interaction component 412 can obtain a response to the request produced from the membership component 410, a positive response associates the user with the travel group. Commonly, the interaction component 412 can implement as a touch screen, a keyboard, microphone, and the like.

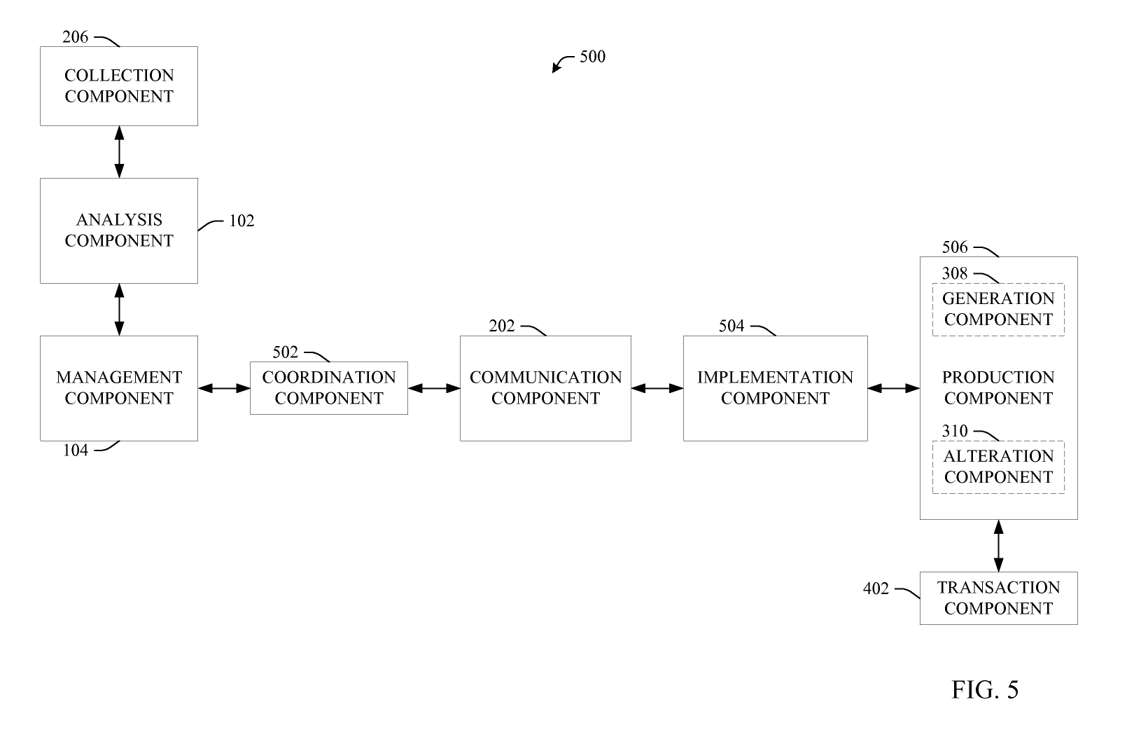

Now referring to FIG. 5, an example system 500 is disclosed for producing a travel group. Multiple users can intend to travel to a common location and a collection component 206 can gather information related to their travel, such as estimated time of departure, paths they intend to take, and the like. Periodic checks to personal electronic devices of the user can be made by the collection component 206, where the device retains travel information that is then accessed. The collection component 206 can implement as a means for gathering data that relates to travel of at least two individuals.

An evaluation of the gathered data can take place through utilization of an analysis component 102. The analysis component 102 can operate as a means for analyzing the gathered data. Comparisons can be made between different users by a management component 104, where comparison results are used to determine if individuals should be grouped together for travel. The management component 104 can function as a means for determining if travel of at least two individuals can be coordinated based upon a result of the gathered data analysis.

It is possible that many individuals match together for grouping into a travel group. A coordination component 502 can determine individuals that should be placed together, such as through utilizing characteristics of the decision component 306 of FIG. 3. The coordination component 502 can perform as a means for coordinating the travel of at least two individuals based upon a positive response to the determination of if travel of at least two individuals can be coordinated.

It is possible for coordination to require approval by at least some individuals in a travel group. A communication component 202 can correspond with different users (e.g., through the management component 410 of FIG. 2 and/or the interaction component 412 of FIG. 4) to determine if a user desires to be part of the travel group. The communication component 202 can implement as a means for communicating with the at least two individuals, communication includes ascertaining if the at least two individuals accept the coordination.

Commonly, individuals can have plans for travel prior to entry in the travel group, such as a route already generated, a schedule a user intends to follow, and the like. An implementation component 504 can alter a schedule of the user, directions of the user, and the like, to facilitate placement in the travel group. For instance, a route from a starting location to an intended destination can modify to include a meeting with another user. The implementation component 504 can function as a means for implementing the coordination upon an agenda (e.g., travel plan) for the at least two individuals.

A production component 506 can be used to output a route that a user can follow to facilitate objective completion for a travel group, where the production component includes a generation component 308 and/or an alteration component 310. According to one embodiment, the generation component 308 produced an initial route, and if a user communicates approval to join a travel group, then the alteration component 310 changes the route to facilitate actions consistent with the travel group, such as meeting with group members. The production component 308 can operate as a means for producing a route, following the produced route facilitates completion of at least one objective of the coordinated individuals.

In addition, a transaction component 402 can be utilized by the system 500 to provide a reward to a user for becoming part of a travel group. For instance, a company can offer a reward for individuals with similar characteristics to travel together so advertising can be more effective (e.g., users travel together that have an affinity for a certain brand of coffee). The transaction component 402 can perform as a means for producing an incentive to at least one individual to the coordination implemented upon the agenda.

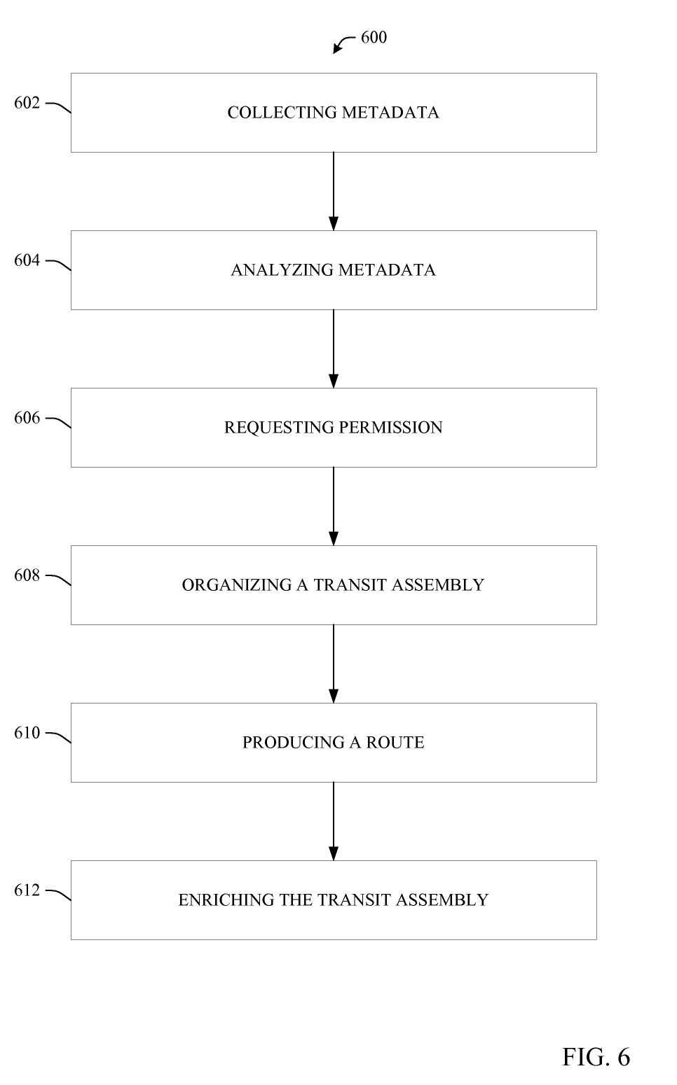

Now referring to FIG. 6, an example methodology 600 is disclosed for producing a route to a user that facilitates membership towards a travel group. Various amounts of metadata can be collected at block 602, the metadata commonly relates to a user that has potential to become part of a travel group and/or areas that can benefit from travel groups (e.g., congested roads). A search can occur to discover potential sources of information and information from those sources can be downloaded, extracted, copied, and the like.

The collected metadata can be analyzed through action 604—specifically, analysis can occur in view of placing members into travel groups. For instance, members of a population that are traveling to a particular location can have their personal interests analyzed to determine other individuals with a similar interest (e.g., if people have a common interest, then they are more likely to enjoy spending time together). At event 606, a request can be made to a user for permission to be placed in a travel group. Two users can be placed into a transit assembly—one user that is a driver and one user that is a passenger, where the driver is to meet the passenger at her home. If the driver is placed in the transit assembly without his approval, then it is possible reliance can be made by the passenger while the driver does not intend to meet the passenger—therefore it can be beneficial to obtain user approval.

At block 608, at least two users can be organized into a transit assembly, commonly taking place in response to the request at event 606. Based upon analysis of the metadata determinations can be made as to what individuals should be placed in a transit assembly. Reasonability tests can occur in relation to the analysis, such that a determination is made if user should be brought together in a transit assembly. If a user is traveling about one-half a mile in distance, then it likely does not make sense to group the user with an individual that is about two cities away—analysis can determine that a match should not be made. In addition, constraints can be placed upon organization of a transit assembly, such as limiting a size of a transit assembly to a number of people that can travel in a specified vehicle, where the transit assembly is to implement upon one vehicle.

At act 610, there can be producing a route automatically that enables at least two individuals in the transit assembly to achieve an individual objective as part of the transit assembly. Oftentimes, a transit assembly can be used to enable at least two individuals to travel to a common location. At least one route can be generated and/or augmented to take the users together and then take the users to the common location.

Members of the transit assembly can be enriched with a reward at event 612. It is possible that acceptance of membership to a transit assembly and/or performance of an action with regard to the transit assembly can be tied with a reward. However, in another configuration, if a user accepts a transit assembly and does not perform a task (e.g., meeting the passenger), then the user can be decremented (e.g., lose money, where the money can transfer to an impacted party, a charity, a government entity, and the like). It is to be appreciated that members of the transit assembly can be provided with different rewards. In an illustrative instance, a driver can be compensated more than passengers can if the driver is using his vehicle.

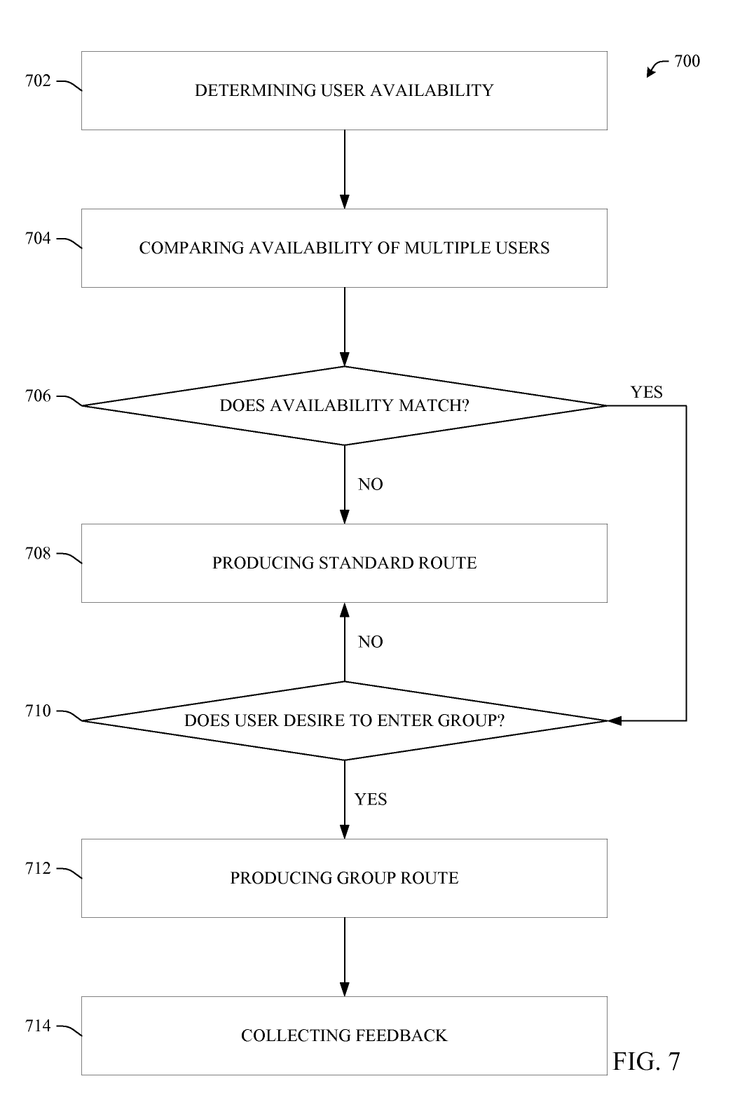

Now referring to FIG. 7, an example methodology 700 is disclosed for producing a route in relation to a travel group. At block 702, a determination can be made as to availability of at least one user with regard to joining a travel group. A user can retain a schedule on a personal electronic device, where the schedule can be used to indicate user availability. For instance, if a user is scheduled to travel between several meetings in a relatively short amount of time, then this can be indicative that the user does not have availability to join a travel group if a stop would make the user late for a meeting.

Availability of multiple users can be compared against one another at action 704. A list can be generated of potential members for a travel group and there can be analysis of availability of the potential members. A check 706 can occur to determine if there is a match of availability of potential users. Matching availability can be exact (e.g., finding members that have equal times open), general (e.g., finding members that have equal times open within a tolerance), complex (e.g., while some users are unavailable, some appointments can be moved to make availability), and the like.

If availability does not match and thus a user should not be placed in a travel group, then a standard route can be produced at act 708. A standard route can be a route that takes a user from a starting location to an intended destination using conventional criteria (e.g., shortest distance, least amount of time, and the like). If availability of a user matches with at least one potential member (e.g., there is an opportunity for a travel group), then a check 710 can determine if a user desires to be part of a travel group. The determination can be made based upon explicit information (e.g., a user response to a direct question), implicit information (e.g., if a user ignores a request after a specific amount of time, then it can be inferred that the user does not desire to enter the group), past history, etc.

If a user does not desire to become part of the travel group, then the methodology 700 can return to act 708 where a standard route is produced. However, if it is determined that the user desires to become part of the travel group, then a route can be produced for the user as well as for other members of the travel group at action 712. Action 712 can include organizing at least two individuals into a transit assembly as well as producing a route automatically that enables at least two individuals in the transit assembly to achieve an individual objective as part of the transit assembly. In addition, feedback related to the methodology 700 can be collected at event 714. Feedback can include if a user found being in the travel group beneficial, if information provided to the user to make decisions is adequate, and so forth. Feedback can be collected through explicitly asking a user questions concerning a travel experience, observing on user conduct, and the like. Feedback can be used to alter operation of methodologies and/or components disclosed in the subject specification.

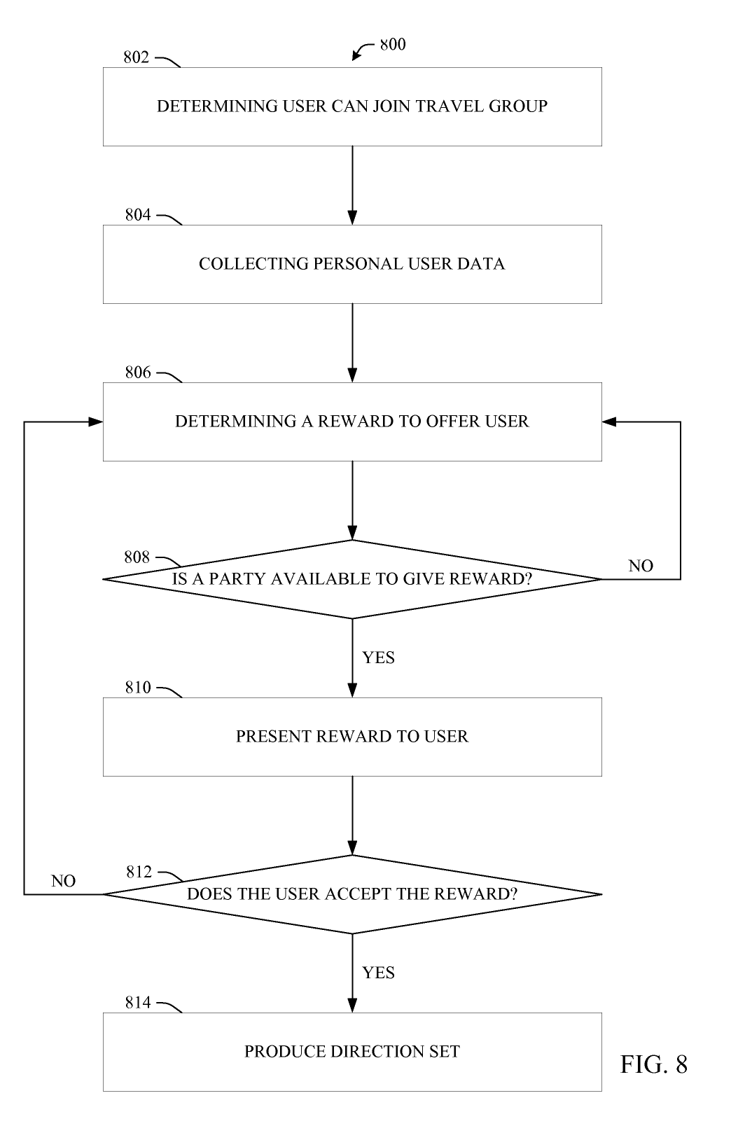

Now referring to FIG. 8, an example methodology 800 is disclosed for producing a direction set with a reward to motivate a user to become part of a travel group. A determination can be made at action 802 on if a user has an ability to join a travel group. A check can be made of a user's schedule in order to determine if there is an ability to join. In an alternative embodiment, if a user is already scheduled to be in a travel group and an appointment takes place that causes the user to exit the travel group, appropriate arrangements can be made automatically (e.g., notify other travel group members of the absence, provide group members in different groups by utilizing aspects disclosed in the subject specification, altering a route, etc.).

Personal data of a user slated for placement in the travel group can be collected at act 804. Commonly, the personal data can be extracted from a profile retained of the user. A determination can be made of a reward that would be likely to motivate the user to take part in a travel group at action 806. The determination can be based upon collected personal data as well as other information (e.g., traffic conditions). For instance, if traffic conditions are expected to be heavy, then there can be more motivation to have a travel group and thus a lower reward can be produced.

A check 808 can occur to determine if a party is available to provide the determined reward. Multiple companies, government entities, and the like can be contacted to provide a reward. Different available rewards can be aggregated in attempt the meet the determined reward. If the reward is not available, then the methodology 800 can return to action 806—a completely new reward can be determined as well as a check if discovered rewards are deemed adequate.

If a reward is found that is estimated to motivate the user to become part of a travel group, then the reward can be presented to a user at event 810. A check 812 can take place to determine if the user accepts the presented reward. If the user does not accept the presented reward, then a new reward can be determined at action 806. The methodology 800 can configure such that after multiple iterations, a standard route can be produced. In addition, a contingency plan can be in place such that a reward cannot be determined and/or no parties can be found such that a standard direction set is produced.

Ultimately, a direction set can be provided to the user that involves activities consistent with membership in a travel group at action 814, often when the user accepts the reward. Action 814 can include organizing at least two individuals into a transit assembly as well as producing a route automatically that enables at least two individuals in the transit assembly to achieve an individual objective as part of the transit assembly. While the disclosed methodology 800 instructs a reward to be determined before a path is found, it is to be appreciated that other configurations are possible, such as collecting potential rewards and then selecting a reward based upon collected personal user data.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

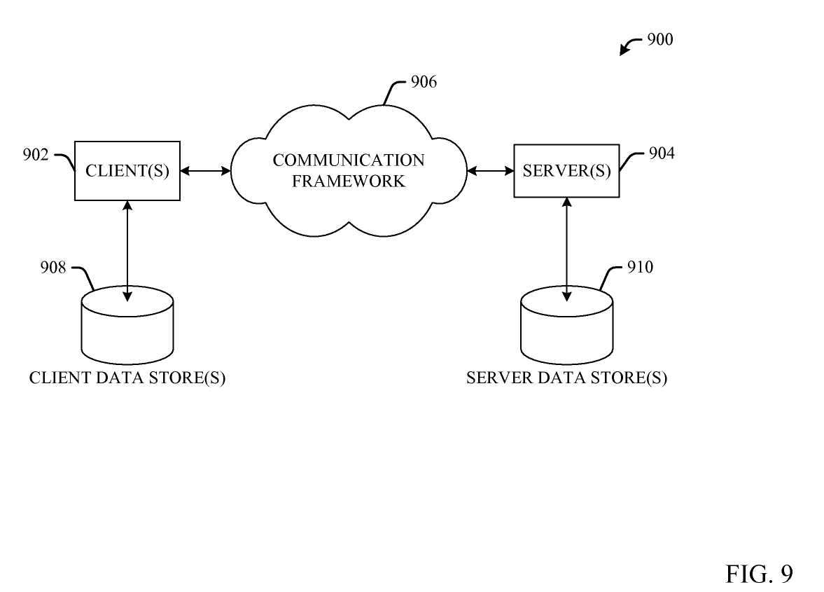

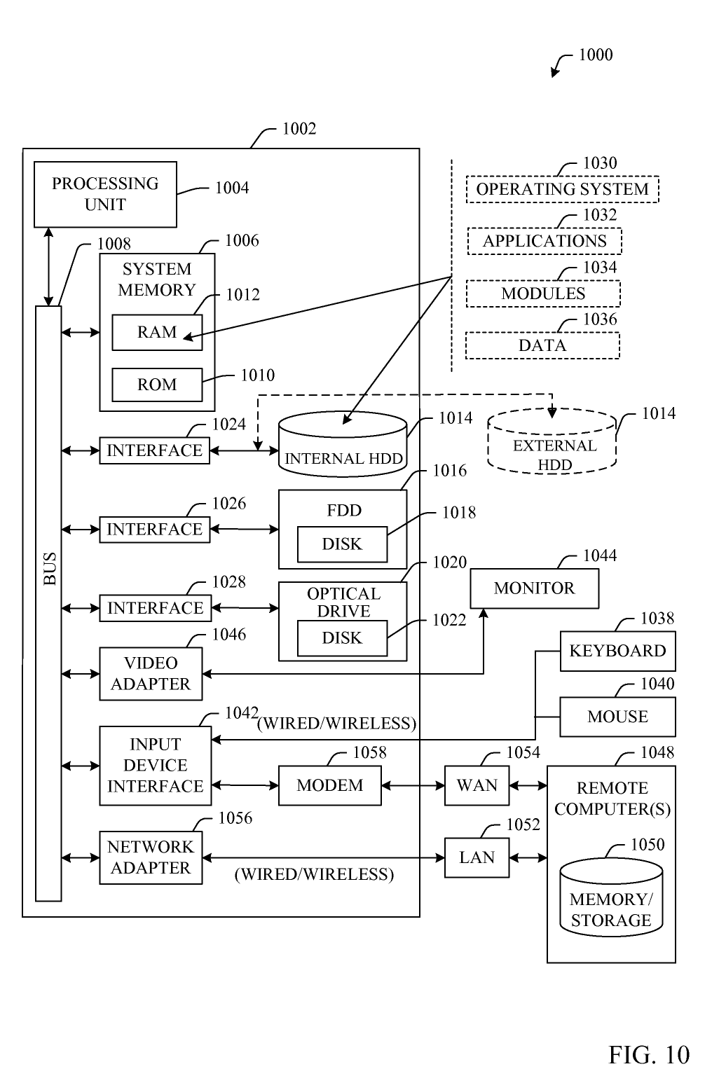

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors or proprietary specific configured processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various proprietary or commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an analysis component that evaluates transit information related to at least two users; and
a management component that automatically organizes at least two users that have transit information evaluated into a travel group, organization occurs as a function of the transit information evaluation.

2. The system of claim 1, the transit information includes schedule information, traffic data, time detail, contextual metadata, a route, or a combination thereof.

3. The system of claim 1, the management component organizes at least two travel groups, organization of the two travel groups occurs to optimize travel for the organized groups.

4. The system of claim 1, the management component that organizes at least two users that have transit information evaluated into a travel group in real time.

5. The system of claim 1, further comprising a transaction component that performs a fiscal operation in regard to transit information evaluation or automatic travel group organization.

6. The system of claim 1, the performed fiscal operation awards a token to a user for participation in a travel group.

7. The system of claim 1, further comprising at least one of the following:
an alteration component that changes a route, use of the changed route enables at least two members of the travel group to achieve a personal objective; or
a generation component that creates a route for the travel group, use of the route enables at least two members of the travel group to achieve a personal objective.

8. The system of claim 1, further comprising a membership component that requests at least one user to become part of the travel group.

9. The system of claim 8, further comprising an interaction component that obtains a response to the request, a positive response associates the user with the travel group.

10. The system of claim 1, at least one user organized into the travel group is part of a complex journey, the user is scheduled to be part of at least two travel groups to reach an intended destination.

11. The system of claim 10, a first travel group of the user takes place upon a personal vehicle, a public transportation vehicle, or a commercial transportation vehicle and a subsequent travel group of the user takes place upon a personal vehicle, a public transportation vehicle, or a commercial transportation vehicle that is not used in the first travel group.

12. The system of claim 1, further comprising an automated reasoning component that makes at least one inference or at least on determination in regard to transit information evaluation or automatic travel group organization.

13. The system of claim 1, the management component implements multiple requests for users to be placed upon a travel group together to minimize overall cost to users, minimize distance traveled, minimize greenhouse gas emissions, or a combination thereof in real-time or offline.

14. A method, comprising
organizing at least two individuals into a transit assembly; and
producing a route automatically that enables at least two individuals in the transit assembly to achieve an individual objective as part of the transit assembly.

15. The method of claim 14, further comprising analyzing metadata related to the at least two individuals, organization is based upon a result of the analysis.

16. The method of claim 15, further comprising collecting the metadata related to the at least two individuals.

17. The method of claim 14, further comprising requesting permission from the at least two individuals, organizing at least two individuals into a transit assembly takes place upon a positive response to the request.

18. The method of claim 14, further comprising enriching at least one individual of the transit assembly with a reward for being part of the transit assembly.

19. A system, comprising:
means for gathering data that relates to travel of at least two individuals;
means for analyzing the gathered data;
means for determining if travel of at least two individuals can be coordinated based upon a result of the gathered data analysis;
means for coordinating the travel of at least two individuals based upon a positive response to the determination of if travel of at least two individuals can be coordinated;
means for communicating with the at least two individuals, communication includes ascertaining if the at least two individuals accept the coordination; and
means for implementing the coordination upon an agenda for the at least two individuals.

20. The system of claim 19, further comprising means for producing an incentive to at least one individual to the coordination implemented upon the agenda.
